(19) United States
(12) Patent Application Publication
(10) Pub. No.: US 2008/0048434 A1
(43) Pub. Date: Feb. 28, 2008

(54) Apparatus and method for authenticating fuse products

(75) Inventor: Mark W. Stavnes, Mount Prospect, IL (US)

Correspondence Address: James V. Lapacek;S & C Electric Co., 6601 N. Ridge Blvd., Chicago, IL, 60626, US

(73) Assignee: S&C ELECTRIC CO., CHICAGO, IL (US)

(21) Appl. No.: 11/820,605

(22) Filed: Jun. 20, 2007

Related U.S. Application Data
(60) Provisional application No. 60/818,838, filed on Jul. 6, 2006.

(51) Int. Cl. B42D 15/10

(52) U.S. Cl. 283/98; 283/74

(57) ABSTRACT

A fault protection device such as a fuse may have a body portion and a displaceable portion mounted to the body portion and displaceable from the body portion as a result of use or operation of the fault protection device. An authentication device is secured to the fault protection device. The authentication device may have a first portion secured to the body portion and a second portion secured to the displaceable portion in a manner that removal of the first portion or the second portion from the body portion and the displaceable portion, respectfully, results in irreparable damage to the authentication device. Furthermore, displacement of the displaceable portion from the body portion as a result of use or operation of the fault protection device results in irreparable damage to the authentication device. The authentication device may also include verifiable indicia authenticating a characteristic of the fault protection device as being genuine.

This application claims the benefit of U.S. Provisional Application No. 60/818,838 filed Jul. 6, 2006.

### TECHNICAL FIELD

This patent relates to fault protection devices typically used in power distributions systems, and more particularly, this patent relates to an apparatus and method that permits reliable authentication of fault protection devices such as fuse products

### BACKGROUND

Power system fault protection device manufacturers for years have encountered both complete counterfeiting as well as rebuilding of their products and in particular power fuses. The counterfeit and/or rebuilt fuses are then sold as new fuses despite neither being the manufacturer's product nor having been “re-loaded” with a new fusible element after having previously interrupted a fault. Clearly either can be very problematic as there is no assurance the copied fuse has been tested or meets the manufacturer's performance specifications, and boric acid fuses, for example, are not designed to be able to interrupt more than once. Additionally, of course, there is lost revenue as a result of missed sales opportunities for the manufacture's fuses instead of the copied or rebuilt fuses as well as potential loss of goodwill as a result of poorly performing counterfeit products being passed off as the manufacturer's own.

Indicators are well known for fuses to allow for visual inspection of the operable state of the fuse. Such indicators, however, are often easily replaced during unauthorized remanufacture of the fuse. Furthermore, the indicator provides no indication of authenticity. This can lead to the problem of not adequately informing the consumer that the purchased product is not genuine and/or may be previously used. Furthermore, field sales organizations upon encountering these suspect devices may have no way to prove to the end user that the device is not authentic and in good operating condition.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a front view depiction of a fuse in accordance with a herein described embodiment of the invention incorporating an authenticating device;

FIG. 2 is an enlarged top view of an end of the fuse depicted in FIG. 1 including the authenticating device;

FIG. 3 is an enlarged top view of the end of the fuse depicted in FIG. 2 after the fuse has blown separating the indicator from the fuse body and affecting the authenticating device;

FIG. 4 is section view of the authenticating device taken along line 4-4 of FIG. 2 including a depiction of the authenticating label; and

FIG. 5 illustrates and alternate configuration for an authenticating device.

### DETAILED DESCRIPTION

To ensure the product being purchased is an authentic, new or properly remanufactured and unused product, an authenticating device is provided in conjunction with the fault protection device. The device may encode, using a coding method known only to the manufacturer or other security entity, data that may indicate the product and its manufacturing date or that may allow a person to easily verify the authenticity, manufacturer and manufacturing date of the product. The coded information, for example, allows a field representative to contact the factory or the security entity or to use field data to verify suspect fuses, and furthermore to allow the representative to be able to provide proof to the end user that the fuses are authentic and/or are not previously used or refurbished. The authenticating device further is responsive to use of the device to indicate such use.

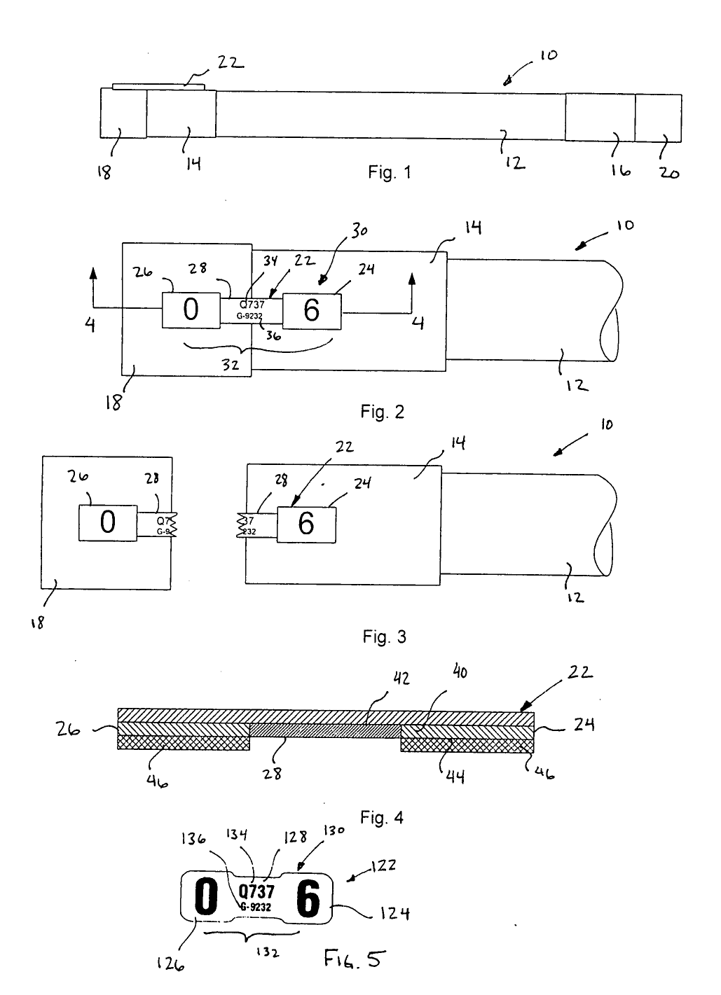

FIG. 1 shows a fuse 10. The fuse 10 may be virtually any type of fuse suitable for use in a power distribution system including boric acid fuses. It will also be appreciated that while the herein described embodiments discuss fuses, the invention may find application with other fault protection devices. The herein described embodiments are particularly suited for use with fault protection devices that have a useful service life regardless of fault operation and those intended for single use after which the device must be either disposed of or suitably repaired or remanufactured.

The fuse 10 may include a fuse body 12, a first ferrule 14, a second ferrule 16, a first protective end cap 18 secured to the first ferrule 14 and a second protective end cap 20 secured to the second ferrule 16. The protective end caps 18 and 20 may seal the internal portion of the fuse, and may be displaced from the fuse 10 by discharge resulting from operation of the fuse to isolate a fault (FIG. 3). In this regard, the end caps 18 and 20 may provide an indication of prior use of the fuse. However, the end caps 18 and 20 are easily replaced in a remanufacturing process, and furthermore do not provide an indication of authenticity, proper repair or remanufacture, no prior use and useful life.

With continued reference to FIG. 1 and reference also to FIGS. 2 and 3, secured to the fuse 10 is an authenticating device such as an encoded label 22. The encoded label 22 spans the first ferrule 14 and the first end cap 18. The encoded label includes a first label portion 24 secured to the first ferrule 14 and a second label portion 26 secured to the first end cap 18, for example, by adhesive bonding. A joining portion 28 joins the first portion 24 and the second portion 26. The joining portion 28 may or may not be secured to the fuse 10. The label 22 further includes indicia 30.

In use, the end caps, and especially end cap 18, may be displaced from the fuse 10 either as a result of the particular installation of the fuse or as a result of operation of the fuse to clear a fault. The end cap 18 being displaced from the fuse 10 is illustrated in FIG. 3. For example, an interior mounting of the fuse 10 may require removal of the end caps 18 and 20 to fit the fuse 10 into the mounting. In an exterior mounting, the end caps 18 and 20 are left in place to provide a weather seal of the ends of the fuse 10. However, during operation of the fuse 10 to clear a fault, discharge as a result of the consumption of the fusible material and/or arc extinguishing material within the fuse 10 displaces the end cap 18. In either case, the end cap 18 is displaced from the fuse 10 as depicted in FIG. 3. Displacement of the end cap 18 from the fuse 10/ferrule 14 results in the fracturing or separating of the joining portion 28 of the label 22 while the portions 24 and 26 remain affixed to the ferrule 14 and the end cap 18, respectively. As will be appreciated, the joining portion 28 is made sufficiently frangible so as to separate, fracture, tear or the like during displacement of the end cap 18 relatively easily. On the other hand, the adhesive securing the label 22 to the end cap 18 and the ferrule 14 is made sufficiently permanent so to prevent easily separating either from the fuse 10 during displacement of the end cap 18. That is, the portion 24 and 26 are intended to be relatively permanently affixed to the ferrule 14 and the end cap 18, respectfully, such that these portions would be damaged upon removal from the fuse 10 and a suitable adhesive to achieve this purpose is to be used. Additional features of the label 22 making it tamper evident, such as scoring of the portions 24 and 26, may also be employed, as is known in the art.

The indicia 30 may convey several pieces of information, and the information may or may not be encoded. For example, the indicia 30 may include a date portion 32 and one or more manufacturing, sequence, authenticity or other code portions 34 and 36. The date portion 32 may provide a clear date indication such as the year of manufacture. As depicted the “0” and “6” indication on the label 20 provide an indication of manufacture in 2006. The first code portion 34 may be a sequence, a serial number, a product code number, or the like. The information provided by the first code portion 34 may be published and used by end users, or the code may be kept secret. Similarly, the second code portion 36 may be a sequence, a serial number, a product code number, or the like. Each of the first code portion 34 and the second code portion 36 is depicted as having an alpha portion and a numeric portion. In one embodiment, the alpha portion of one of the first code portion 34 or the second code portion 36 may indicate a month of manufacture, while the numeric portion serve as an authentication portion. The authentication portion may be a random code known only to the manufacturer, or the authentication portion may be other data or indications. For example, while shown as alpha/numeric sequence, the authentication portion may be another type of authenticating indicia. For example, replacing the numeric segment may be a watermark, hologram or virtually any other identifying indicia.

Referring to FIG. 4, the label 22 may include a substrate 40 having a first side 42 and a second side 44. The substrate 40 may be a continuous sheet of material or may be separate pieces of material joined together to form the substrate. The portions 24, 26 and 28 are depicted separately, but such depiction of the substrate 40 should not be interpreted as requiring the substrate 40 to be formed of separate elements or portions. While it may be so formed, the portions 24, 26 and 28 are separately indicated for clarity and to permit description of the associated requirements of each. The substrate 40 may be single ply or multiple ply, woven or non-woven material or combinations thereof. Additionally, the first portion 24 and second portion 26 may be formed of a first material while the joining portion 28 may be a second material, different than the first material. At least the joining portion 28 should be frangible or made to be so. Thus the portion 28 may be made of a material that is easily torn and/or may be scored, cut, perforated or otherwise made to allow easy separation of the first portion 24 and the second portion 26.

The indicia 30 may be disposed on the first side while a layer of adhesive 46 may be disposed on the second side 44. The adhesive layer 46 may be formed over the entire second side 44, or may be disposed only in the areas of the first portion 24 and the second portion 26, as shown in FIG. 4. A coating 46 is optional and may be provided over the first surface 42 to resist damage to the indicia 30 as a result of use, weather exposure, manufacture/shipping/storage, and the like of the fuse 10.

As shown in FIG. 1 and FIG. 2, the label 22 is secured to the fuse 10, and in particular spanning the first ferrule 14 and the first end cap 18. The first end cap 18 is intended to be displaced from its normal position as a result of operation of the fuse, and as such serves as an indicator of fuse operation. Alternatively, the first end cap 18 may be removed from the fuse 10 upon installation. In either case, the label 22 and in particular the joining portion 18 is caused to fracture irreparably damaging the label 22 and/or rendering a portion of the indicia 30 unreadable or uninterpretable (FIG. 3) upon either the installation, use or operation of the fuse 10. The label 22 therefore secures to a use indicator member of the fuse 10 that is separated from the fuse 10 during use. The label 22 may be secured to other portions of the fuse 10, such as the body 12, the second ferrule 16, the second end cap 20, and the like, provided that the label secures to a portion of the fuse that is displaced from the fuse as a result of normal use so that the label 22 is permanently and irreparably damaged as a result of such use. Thus, the label 22 provides an indication of authenticity by way of its inclusion of indicia 30, and furthermore provides an indication of the unused and ready state of the fuse.

FIG. 5 illustrates an alternative configuration of a label 122, similar to label 22, and like elements are indicated by like references numerals incremented by 100. The labels, such as label 22 or label 122, may be printed using commercially available label printers. In this regard, the labels may be provide on liner or linerless stock feed through the printer which forms the indicia thereon. The encoded labels may then be manually or automatically affixed to the fault protection devices during manufacture of the same.

As noted above, the encoded data may be maintained by the manufacturer or in the alternative, a security entity may be employed that, for security purposes, maintains the encoded data separately from the manufacturing facility. In such an arrangements the printers within the manufacturing facility may be communicatively linked with the security entity to receive encoded data or may be manually encode with the data be an authorized person. The encoded data is then transferred to the labels via the printing process, and the labels are affixed to the fault protection devices. The security data may be maintained as part of a database that may be accessed via a secured Internet or other suitable communication connection to either the manufacturing facility or the security entity based upon where the information is maintained. Importantly, the database, and the ability to interpret the encoded data, is maintained separate from a distributor, a storage facility or a place of use of the fault protection device so that it may be compromised and used to generate counterfeit labels. Field representatives may alternatively be provided the data on handheld electronic devices, laptop computer devices or in printed form, allowing them to easily determine the authenticity of the fault protection device in the field.

Thus, an authentication device in accordance with the various described embodiments provides an immediate visual indication of the state of the fault protection device, i.e., the damaged or undamaged state of the device; an immediate visual indication of the age of the fault protection device, i.e., by including decoded date data, and an ability to authenticate the fault protection device, i.e., by remote communication or onsite lookup verification of the encoded data and/or by verification of other indicia included with the authentication device.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fault protection device comprising: a body portion and a displaceable portion mounted to the body portion and displaceable from the body portion as a result of use or operation of the fault protection device, an authentication device secured to the fault protection device, the authentication device having a first portion secured to the body portion and a second portion secured to the displaceable portion, the first portion and the second portion being secured in a manner that removal of the first portion or the second portion from the body portion and the displaceable portion, respectfully, results in irreparable damage to the authentication device and displacement of the displaceable portion from the body portion as a result of use or operation of the fault protection device results in irreparable damage to the authentication device, wherein the authentication device includes verifiable indicia authenticating a characteristic of the fault protection device as being genuine.

2. The fault protection device of claim 1, wherein the authentication device comprises a joining portion disposed between the first portion and the second portion, the joining portion being frangible and the joining portion being irreparably damaged as a result of use or operation of the fault protection device.

3. The fault protection device of claim 2, at least a portion of the indicia being disposed on the joining portion.

4. The fault protection device of claim 3, a least a portion of the indicia being disposed on the joining portion being rendered uninterpretable as a result of use or operation of the fault protection device.

5. The fault protection device of claim 1, the indicia comprising remotely verifiable encoded data.

6. The fault protection device of claim 5, decoding data maintained remotely of a distributor, storage facility or place of installation or use of the fault protection device.

7. The fault protection device of claim 6, the decoding data maintained at the manufacturing facility or a security entity separate and apart from the manufacturing facility.

8. The fault protection device of claim 6, the decoding data being accessible via an Internet connection.

9. The fault protection device of claim 6, the decoding data being maintained on a portable electronic device.

10. The fault protection device of claim 1, the indicia comprising a watermark or hologram.

11. The fault protection device of claim 1, the authentication device comprising a printed label.

12. The fault protection device of claim 1, the fault protection device comprising a fuse.

13. The fault protection device of claim 12, body portion comprising a ferrule and the displaceable portion comprising an end cap mounted to and displaceable from the ferrule.

14. The fault protection device of claim 1, the indicia comprising uncoded data.

15. The fault protection device of claim 14, the uncoded data including data indicative of a date of manufacture.

16. A method of indicating an authenticity of a fault protection device comprising: affixing to the fault protection device an authentication device, permanently and irreparably damaging the authentication device as a result of use or operation of the fault protection device and providing on the authentication device verifiable indicia authenticating a characteristic of the fault protection device as being genuine.

17. The method of claim 16, comprising printing a label and affixing the label to separate portions of the fault protection device that are displaced relative to each other as a result of use or operation of the fault protection device such that the label is permanently and irreparably damaged as a result of the use or operation of the fault protection device.

18. The method of claim 16, wherein the verifiable indicia comprises encoded data and the method comprises maintaining remotely from a distributor, a storage facility or a place of use of the fault protection device a database of information, the information allowing for the decoding of the encoded data to verify characteristic as genuine.
